(19) United States
(12) Patent Application Publication
(10) Pub. No.: US 2025/0370867 A1
(43) Pub. Date: Dec. 4, 2025

(54) MEMORY SUB-SYSTEM FOR MANAGING BLOCK STRIPE ASSIGNMENT BASED ON BLOCK ERROR CONDITIONS

(71) Applicant: Micron Technology, Inc., Boise, ID (US)

(72) Inventors: Noorshaheen Mavungal Noorudheen, Longmont, CO (US); Paul Roger Stonelake, Kihei, HI (US); Byron D. Harris, Mead, CO (US)

(21) Appl. No.: 19/219,935

(22) Filed: May 27, 2025

Related U.S. Application Data
(60) Provisional application No. 63/652,295, filed on May 28, 2024.

(51) Int. Cl. G06F 11/10

(52) U.S. Cl. CPC G06F 11/1068; G06F 11/1048

(57) ABSTRACT

Various aspects of the present disclosure relate to a process for managing block stripe assignment based on block error conditions. A processing device may identify, for a plurality of block stripes associated with a memory device, respective quantities of blocks that are associated with an error condition. The processing device may designate a first block stripe of the plurality of block stripes as a single-level cell (SLC) block stripe based on a first quantity of blocks in the first block stripe that are associated with the error condition, and may designate a second block stripe of the plurality of block stripes as a quad-level cell (QLC) block stripe based on a second quantity of blocks in the second block stripe that are associated with the error condition, where the first quantity is greater than the second quantity.

### RELATED APPLICATIONS

This application claims the benefit of U.S. Provisional Patent Application No. 63/652,295, filed May 28, 2024, the entire contents of which are hereby incorporated by reference herein.

### TECHNICAL FIELD

Aspects of the disclosure relate generally to memory sub-systems, and more specifically, to a memory sub-system for managing block stripe assignment based on block error conditions.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various aspects of the disclosure.

FIG. 1 illustrates an example computing system that includes a memory sub-system, in accordance with some aspects of the present disclosure.

FIG. 2 is a sequence diagram of an example method of managing block stripe assignment based on block error conditions, in accordance with some aspects of the present disclosure.

FIGS. 3A-3B illustrate an example of logical unit number stripes that include bad blocks, in accordance with some aspects of the present disclosure.

FIG. 4 illustrates examples of bad block distributions in a memory device, in accordance with some aspects of the present disclosure.

FIG. 5 is a flow diagram of an example method of managing block stripe assignment based on block error conditions, in accordance with some aspects of the present disclosure.

FIG. 6 is a block diagram of an example computer system in which some aspects of the present disclosure may operate.

### DETAILED DESCRIPTION

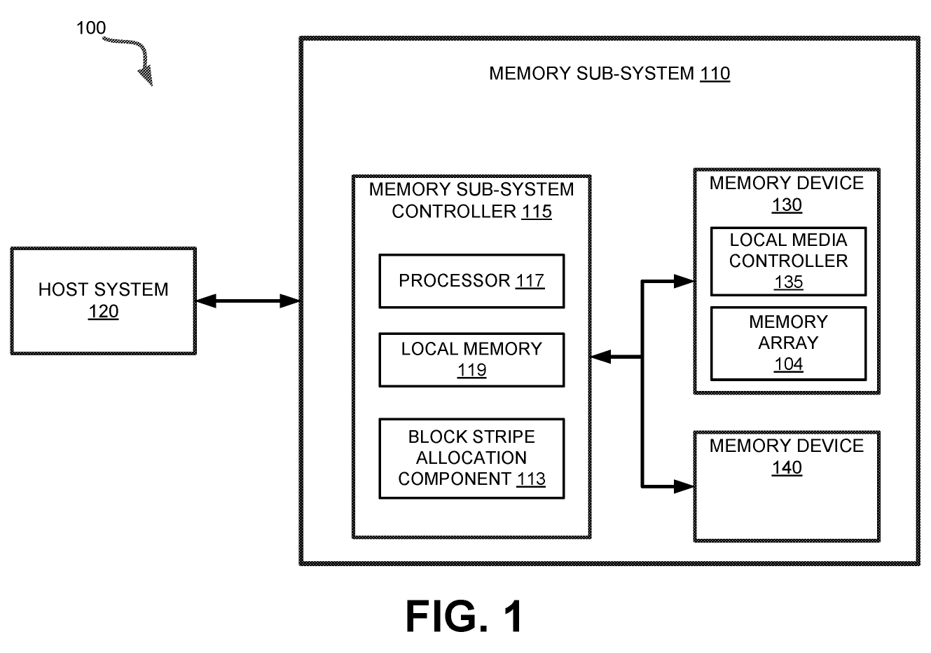

Aspects of the present disclosure are directed to a memory sub-system for managing block stripe assignment based on block error conditions. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or a three-dimensional grid. Memory cells are formed onto a silicon wafer in a rectangular array; the memory cells may be joined by conductive lines referred to as wordlines and bitlines. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

A memory device may include different types of memory distributed across multiple portions of the memory device. Data at one portion of the memory (for example, the NAND memory) may be arranged according to a file system. A file system is a data structure that can be used by the memory sub-system to control how data is stored and retrieved. For example, the file system may organize data into files and directories in order to allow users and applications to store and retrieve data efficiently. Another portion of the NAND memory may include single-level cell (SLC) memory. In SLC memory, each memory cell stores a single bit of data. SLC memory may have high-speed, high-durability, and low power-consumption compared to other types of memory, but at a higher cost per-bit of storage. Another portion of the NAND memory may include multi-level cell (MLC) memory. MLC memory stores multiple bits of data per memory cell, which allows for higher storage density and lower cost per bit compared to SLC memory. One example type of MLC memory is quad-level cell (QLC) memory which stores four bits of data per memory cell. However, MLC memory has slower write speeds and lower endurance because of the complexity of managing more bits per cell. Another portion of the memory may include flash translation layer (FTL) memory. FTL memory is firmware layer memory that can be used to map logical block addresses (LBA) to physical block addresses on the memory device. FTL memory may be used for managing wear leveling and garbage collection operations, among other examples.

Data may be stored in a memory device using block stripes, where each block stripe spans multiple dies (for example, all dies) of the memory device and includes multiple data blocks. The blocks stripes may be designated for certain types of memory in the memory device, for example, during a manufacturing process of the memory device. The block stripes may be designated for the certain types of memory in a chronological order. For example, a first twenty percent (or a first quantity) of the block stripes may be designated as SLC block stripes (such as FTL block stripes and cache block stripes) and a remaining eighty percent (or a remaining quantity) of the block stripes may be designated as QLC block stripes. In some cases, a block stripe may include one or more bad blocks. A bad block is a block that is associated with an error condition. For example, a bad block may result from a manufacturing defect or physical damage to the memory device, among other examples. The memory device may be able to be used even if the memory device includes a certain number of bad blocks. However, an increase in the number of bad blocks results in an increased likelihood that the memory device will fail or need to be discarded. Different types of memory may be able to tolerate different quantities of bad blocks. For example, SLC memory may be able to tolerate a higher quantity of bad blocks due to a lower quantity of block stripes that are required to operate in parallel, whereas QLC memory may be able to tolerate a lower quantity of bad blocks due to a higher quantity of block stripes that are required to operate in parallel. However, it may not be possible for block stripes having a larger quantity of bad blocks to be used for SLC memory and for block stripes having a smaller quantity of bad blocks to be used for QLC memory due to the block stripes being assigned chronologically and due to the bad blocks being located randomly on the die. This may result in an increased number of memory devices failing or being discarded.

Aspects of the present disclosure address the above and other deficiencies by implementing a memory sub-system for managing block stripe assignment based on block error conditions. A memory sub-system controller may identify quantities of bad blocks in multiple block stripes of the memory device, where each bad block corresponds to a block that is associated with an error condition, and where each block stripe of the multiple block stripes spans multiple blocks (for example, all blocks) of the memory device. The memory sub-system controller may designate a first block stripe and a second block stripe of the multiple block stripes as a block stripe with memory having a first number of bits per cell and a block stripe with memory having a second number of bits per cell, respectively, based on the quantities of bad blocks associated with the first block stripe and the second block stripe. For example, the memory sub-system controller may designate the first block stripe as a block stripe with memory having a lower number of bits per cell based on the first block stripe having a higher quantity of bad blocks than the second block stripe and may designate the second block stripe as a block stripe with memory having a higher number of bits per cell based on the second block stripe having a lower quantity of bad blocks than the first block stripe. In some aspects, the block stripe with memory having the first number of bits per cell is an SLC block stripe and the block stripe with memory having the second number of bits per cell is a QLC block stripe. Therefore, the memory sub-system controller may designate the first block stripe having the higher number of bad blocks as the SLC block stripe and may designate the second block stripe having the lower number of bad blocks as the QLC block stripe. In some aspects, each block stripe of the multiple block stripes may span multiple logical unit numbers of the memory device, and a quantity of SLC block stripes of the memory device may be divided equally among the multiple logical unit numbers. For example, in a memory device that includes two logical unit numbers and 64 SLC block stripes, 32 SLC block stripes may be allocated to a first logical unit number and another 32 of the SLC block stripes may be allocated to a second logical unit number. In some aspects, the SLC memory may include FTL memory and cache memory, and the memory sub-system controller may designate one or more block stripes having the higher quantity of bad blocks as FTL memory and may designate one or more other block stripes having the higher quantity of bad blocks as cache memory.

Some advantages of the present disclosure include increasing memory device and block stripe flexibility. For example, identifying the quantity of bad blocks in multiple block stripes of the memory device may enable the block stripes to be dynamically designated as SLC block stripes or QLC block stripes. Some advantages of the present disclosure include increasing memory device yield. For example, designating the block stripes as SLC block stripes or QLC block stripes based on the quantity of bad blocks in the block stripes may decrease the number of memory devices that need to be discarded after manufacture. Some advantages of the present disclosure include increasing diversity in memory devices. For example, one memory device may have a higher number of SLC block stripes and a lower number of QLC block stripes based on the memory device having a higher number of bad blocks, while another memory device may have a lower number of SLC block stripes and a higher number of QLC block stripes based on the memory device having a lower number of bad blocks. These example advantages, among others, are described in more detail herein.

FIG. 1 illustrates an example computing system 100 that includes a memory sub-system 110, in accordance with some aspects of the present disclosure. The memory sub-system 110 can include media, such as one or more volatile memory devices (e.g., memory device 140), one or more non-volatile memory devices (e.g., one or more memory device(s) 130), or a combination of such.

The memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some aspects, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the physical host interface (e.g., PCIe or CXL interface). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some aspects, each of the memory devices 130 can include one or more arrays of memory cells such as SLCs, MLCs, TLCs, QLCs, or any combination of such. In some aspects, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some aspects, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in some other aspects, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some aspects, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some aspects, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some aspects, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some aspects, one or more components of memory sub-system 110 can be omitted.

In some aspects, the memory sub-system 110 includes a block stripe allocation component 113 that can be used to allocate block stripes based on quantities of bad blocks in the block stripes. In some aspects, the block stripe allocation component 113 may identify, for multiple block stripes, respective quantities of blocks that are associated with an error condition. The block stripe allocation component 113 may designate a first block stripe as a block stripe with memory having a first number of bits per cell based on a corresponding first quantity of blocks in the first block stripe that are associated with the error condition, and may designate a second block stripe as a block stripe with memory having a second number of bits per cell based on a corresponding second quantity of blocks in the second block stripe that are associated with the error condition, where the corresponding first quantity is greater than the corresponding second quantity. For example, the block stripe allocation component 113 may designate the first block stripe as an SLC block stripe and may designate the second block stripe as a QLC block stripe based on the first block stripe having a higher quantity of bad blocks than the second block stripe. Additional details regarding these features are described below.

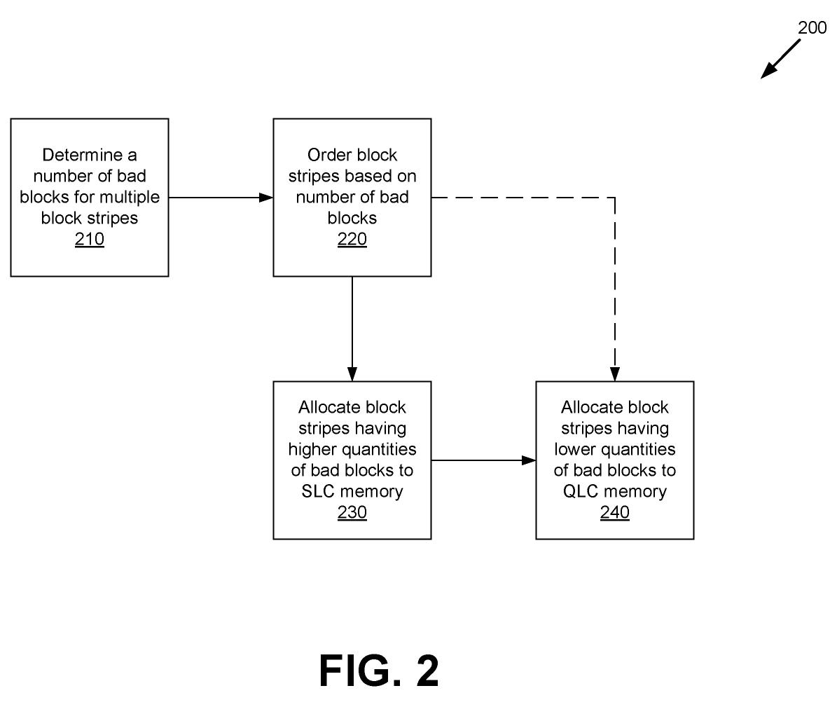

FIG. 2 is a sequence diagram of an example method 200 of managing block stripe assignment based on block error conditions, in accordance with some aspects of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, the method 200 is performed by the block stripe allocation component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

Smart die matching (SDM) is a process used in the manufacturing of semiconductor devices, such as NAND flash memory devices, that includes strategically pairing dies of varying performance levels within a single package or across multiple wafers. The goal of SDM is to optimize the overall performance of the memory device by balancing the variability in individual die quality, thereby improving product reliability. For example, dies having a higher quality and dies having a lower quality may be distributed across multiple memory devices. This may result in memory devices being equipped with one or more die having the higher quality and one or more die having the lower quality, rather than some memory devices having all dies of the higher quality and some other memory devices having all dies of the lower quality (and therefore, needing to be discarded). One potential benefit of SDM is the reduction in the requisite number of spare NAND blocks, which may lead to a decrease in the size of the die. Despite these advantages, the application of SDM may result in non-uniform block stripes and a larger variance in the number of blocks per block stripe, potentially impacting device performance. To mitigate such disparities, an optimal block skewing offset may be implemented for each drive. A skewing offset, which may be defined as the displacement applied to block mapping to counteract uneven wear or defects, may balance the distribution of bad blocks across the block stripes and, therefore, minimize the variance in block counts. In some examples, the skewing offset may be applied using plane level block skewing. Plane level block skewing is a technique that involves applying a constant offset to the plane numbers during the block mapping process. This method is designed to create a diagonal mapping scheme across different planes of the memory device. By shifting the block addresses in this diagonal pattern, plane level block skewing helps distribute wear and data more evenly across all memory planes, which may enhance the endurance and reliability of the memory device by preventing any single plane from experiencing excessive wear or data concentration.

A block stripe may include one or more bad blocks. An increase in the number of bad blocks may result in an increased likelihood of the memory device that includes the bad blocks needing to be discarded. Different types of memory may be able to tolerate different quantities of bad blocks. For example, SLC memory may be able to tolerate a higher quantity of bad blocks due to a lower quantity of block stripes that are required to operate in parallel, whereas QLC memory may be able to tolerate a lower quantity of bad blocks due to a higher quantity of block stripes that are required to operate in parallel. Therefore, it may be desirable to allocate block stripes having a higher quantity of bad blocks to SLC memory and to allocate block stripes having a lower quantity of bad blocks to QLC memory.

In some examples, different types of memory may have different performance requirements, such as different write bandwidth requirements. For example, a smaller number of active LUNs (such as ten active LUNs) may be needed simultaneously in order to satisfy a write performance requirement for memory having a lower number of bits per cell (such as SLC memory). However, a higher number of active LUNs (such as fifty active LUNs) may be needed to satisfy a write performance requirement for memory having a higher number of bits per cell (such as QLC memory). Therefore, it may be desirable to allocate block stripes having a higher quantity of bad blocks to SLC memory and to allocate block stripes having a lower quantity of bad blocks to QLC memory, for example, since SLC memory is can still satisfy the write performance requirement even with the higher number of bad blocks.

At operation 210, the processing logic determines a number of bad blocks for multiple block stripes in the memory device. For example, the processing logic may identify a number of block stripes in the memory device, and may determine, for each block stripe, the number of bad blocks included in the block stripe. In one example, the memory device may include 600 block stripes. The number of block stripes in the memory device may increase with the size of the memory device. For example, a 128 terabyte memory device may include significantly more block stripes than a 2 terabyte memory device.

The processing logic may determine the number of bad blocks in the block stripes using factory testing, self-monitoring, analysis, and reporting technology (SMART) monitoring, or error checking, among other examples. Factory testing may include scanning for defective areas in the memory device during the manufacturing process. Blocks found to be defective may be marked as bad in the factory and may be mapped out of the usable storage area. SMART monitoring is a monitoring system included in some memory devices that continuously monitors drive parameters such as performance, error rates, and overall health. SMART monitoring can detect when a block is becoming unreliable before it fails completely. Error checking can be performed during operation of the memory device. Memory devices can perform error checking using techniques such as error correcting code (ECC) during regular operations. When data is written to a block, ECC codes are also written. Upon reading the data, if the ECC code does not match the data, the block may be indicated as a bad block.

At operation 220, the processing logic orders the block stripes based on the number of bad blocks in the block stripes. For example, the processing logic may sort the block stripes into a list of block stripes ordered from block stripes having the highest number of bad blocks to block stripes having the lowest number of bad blocks.

At operation 230, the processing logic allocates block stripes having higher quantities of bad blocks to the SLC memory. In some aspects, the processing logic may allocate a specified quantity of block stripes having the highest number of bad blocks to the SLC memory. For example, the processing logic may allocate the first one hundred block stripes in the list of block stripes to the SLC memory. In some other aspects, the processing logic may allocate a certain percentage of block stripes having the highest number of bad blocks to the SLC memory. For example, the processing logic may allocate the first ten percent of block stripes having the highest number of bad blocks to the SLC memory.

At operation 240, the processing logic allocates a remainder of the block stripes to the QLC memory. For example, the processing logic may allocate the remaining five hundred block stripes to the QLC memory or may allocate the remaining ninety percent of block stripes to the QLC memory.

The SLC memory and QLC memory are provided as example types of memory. In some aspects, the memory may include different types of memory. For example, the processing logic may allocate a first quantity (or first percentage) of block stripes as block stripes with memory having a first number of bits per cell based on a corresponding first quantity of blocks in the first block stripe that are associated with the error condition, and may allocate a second quantity (or second percentage) of block stripes as block stripes with memory having a second number of bits per cell based on a corresponding second quantity of blocks in the second block stripe that are associated with the error condition, where the first number of bits per cell is lower than the second number of bits per cell, and the corresponding first quantity is greater than the corresponding second quantity. Additional details regarding these features are described herein.

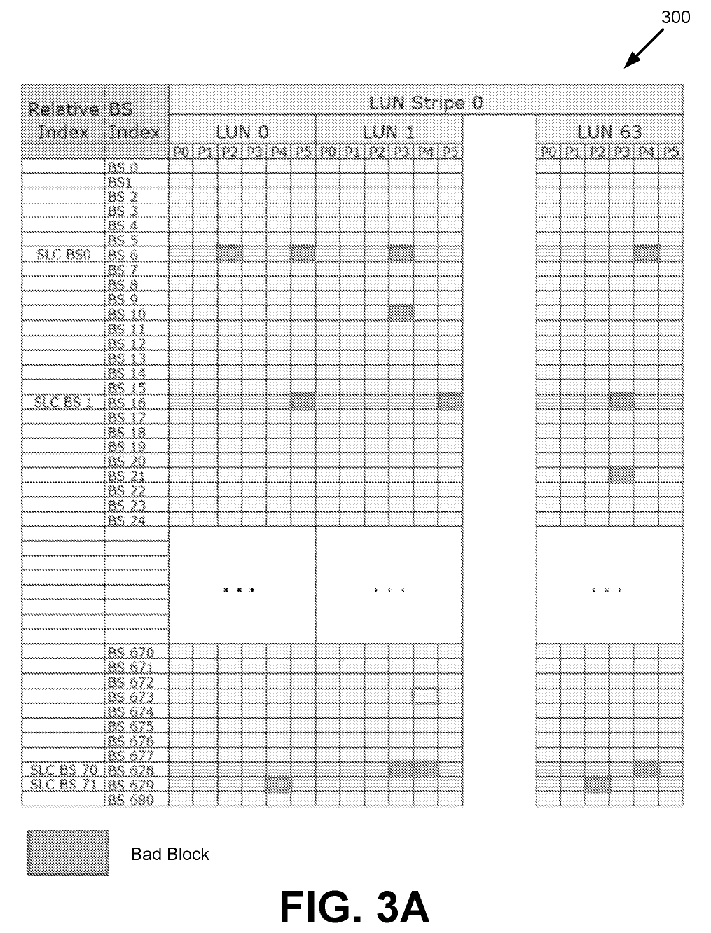

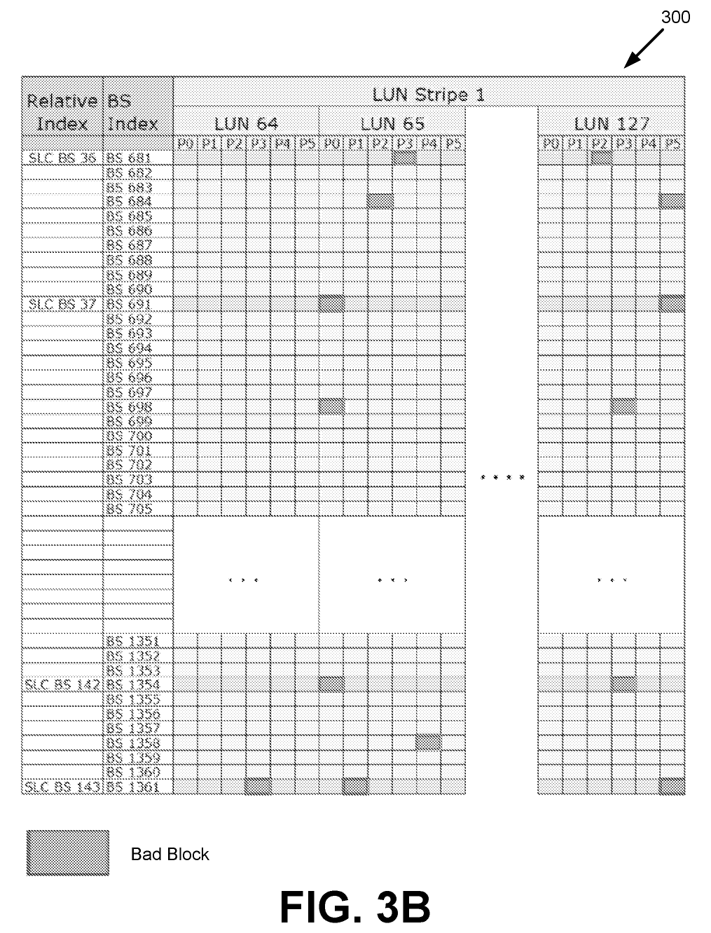

FIGS. 3A-3B illustrate an example 300 of logical unit number stripes that include bad blocks, in accordance with some aspects of the present disclosure. A logical unit number (LUN) is an identifier that is used for addressing a logical unit of memory. The logical unit of memory may correspond to a portion of memory in a memory device, an entirety of memory in the memory device, or a subset of memory in a larger memory array. In some cases, the LUN may be used to distinguish among various storage devices or partitions within a network or single computer system. For example, in a storage area network (SAN) environment that allows multiple computers (servers) to connect and interact with multiple storage devices over a network, the LUN may be used for determining the boundaries for the data storage and access, where each device or partition within these devices is assigned a unique LUN. In some cases, LUNs can be used to facilitate the virtualization of storage, such that a single physical storage device can be divided into multiple logical units, each perceived by the operating system as a distinct device capable of being managed separately.

As shown in the example 300, a LUN stripe may include multiple LUNs that are distributed across multiple dies (for example, all dies) of a memory device. For example, a first LUN stripe (shown as LUN stripe 0) may include 64 LUNs (shown as LUN 0 through LUN 63) and a second LUN stripe (shown as LUN stripe 1) may include another 64 LUNs (shown as LUN 64 through LUN 127). Each LUN included in a LUN stripe may include multiple blocks. For example, each LUN included in a LUN stripe may include six blocks, shown P0, P1, P2, P3, P4, and P5. Different block stripes may be allocated to different LUN stripes. For example, block stripe 0 (shown as BS 0) through block stripe 680 (shown as BS 680) may be allocated to LUN stripe 0 (and, therefore, may be allocated to LUN 0 through LUN 63) and block stripe 681 (shown as BS 681) through block stripe 1361 (shown as BS 1361) may be allocated to LUN stripe 1 (and, therefore, may be allocated to LUN 64 through LUN 127). In some aspects, the number of LUNs in the memory device may be evenly distributed across the LUN stripes. For example, for a memory device with two LUNs and 72 SLC block stripes (including the cache and FTL memories), 36 block stripes may be allocated to one LUN stripe and another 36 block stripes may be allocated to another LUN stripe.

As described herein, a memory sub-system controller may determine a quantity of bad blocks across multiple block stripes of a memory device. A bad block may be a block that is associated with an error condition, such as an error condition caused by a manufacturing defect or physical damage to the memory device. The memory sub-system controller may assign block stripes having higher quantities of bad blocks to a first type of memory having a lower number of bits per cell (such as SLC memory) and may assign block stripes having lower quantities of bad blocks to a second type of memory having a higher number of bits per cell (such as QLC memory). For example, the memory sub-system controller may assign a first quantity of the block stripes (such as four block stripes), or a first percentage of the block stripes (such as twenty percent of the block stripes) having the highest quantities of bad blocks to the SLC memory and may assign a remainder of the block stripes to the QLC memory. In some aspects, the quantity or percentage of block stripes that are designated as the first type of block stripe and the second type of block stripe may be the same across the multiple LUN stripes. For example, four block stripes having the highest quantity of bad blocks in the first LUN stripe may be designated as SLC block stripes and four block stripes having the highest quantity of bad blocks in the second LUN stripe may be designated as SLC block stripes.

As shown in the example 300, for LUN stripe 0, BS 6 may include four bad blocks, BS 10 may include a single bad block, BS 16 may include three bad blocks, BS 21 may include a single bad block, BS 678 may include three bad blocks, and BS 679 may include three bad blocks. Therefore, the memory sub-system controller may designate the four block stripes having the highest quantity of bad blocks (BS 6, BS 16, BS 678, and BS 679) as SLC block stripes (SLC BS 0, SLC BS 1, SLC BS 70, and SLC BS 71, respectively), and may designate a remainder of the block stripes in LUN stripe 0 as QLC block stripes. Additionally, for LUN stripe 1, BS 681 may include two bad blocks, BS 684 may include two bad blocks, BS 691 may include two bad blocks, BS 698 may include two bad blocks, BS 1354 may include two bad blocks, BS 1358 may include a single bad block, and BS 1361 may include three bad blocks. Therefore, the memory sub-system controller may designate the four block stripes having the highest quantity of bad blocks (BS 681, BS 691, BS 1354, and BS 1361) as SLC block stripes (SLC BS 36, SLC BS 37, SLC BS 142, and SLC BS 143, respectively), and may designate a remainder of the block stripes in LUN stripe 1 as QLC block stripes. In some aspects, if there are multiple block stripes having the same quantity of bad blocks, the bad blocks may be assigned as SLC block stripes or QLC block stripes based on a random assignment, or based on a chronological assignment, among other examples.

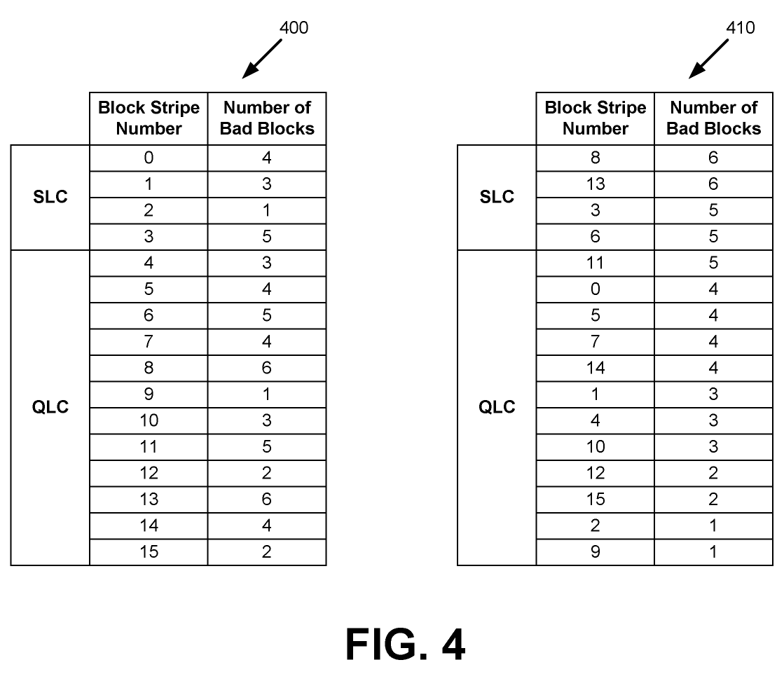

FIG. 4 illustrates examples 400 and 410 of bad block distributions in a memory device, in accordance with some aspects of the present disclosure.

As described herein, block stripes may be assigned to SLC memory or QLC memory in chronological order. For example, a first quantity of block stripes (or a first percentage of block stripes) in the memory device may be assigned to the SLC memory and a remainder of the block stripes may be assigned to the QLC memory. As described herein, the memory device may include multiple bad blocks that are distributed across the block stripes of the memory device randomly. Therefore, block stripes having bad blocks may have the same likelihood of being assigned to the SLC memory or the QLC memory. As shown in FIG. 4, a memory device may include sixteen block stripes, each block stripe having a corresponding number of bad blocks. Four block stripes may be assigned to the SLC memory, and twelve block stripes may be assigned to the QLC memory. This distribution is provided for the purposes of example only. In some aspects, the number of block stripes in the memory device may be greater (for example, significantly greater) than sixteen. For example, a two-terabyte (2T) NAND memory device may have 552 block stripes.

As shown in the example 400, the block stripes may be assigned to the SLC memory and the QLC memory chronologically. The first four block stripes (block stripes 0-3) may be assigned to the SLC memory, and the remaining twelve block stripes (block stripes 4-15) may be assigned to the QLC memory. This may result in the SLC memory having a higher quantity of bad blocks (compared to other distributions, such as shown in example 410). For example, two of the block stripes in the QLC memory may have six bad blocks and two of the block stripes in the QLC memory may have five bad blocks. In this example, the average number of bad blocks in the SLC memory is 3.25 and the average number of bad blocks in the QLC memory is 3.75. An increased number of bad blocks in the QLC memory may increase a likelihood that the memory device will fail or need to be discarded, for example, due to the QLC memory requiring a higher quantity of block stripes to operate in parallel.

In some aspects, block stripes may be assigned to the SLC memory or QLC memory based on the quantity of bad blocks included in the block stripe. For example, the block stripes may be ordered from block stripes having the highest number of bad blocks to block stripes having the lowest number of bad blocks. The memory sub-system controller may allocate a first quantity of block stripes (or a first percentage of block stripes) from the list of block stripes to the SLC memory and may allocate a remainder of the block stripes to the QLC memory. This improves a likelihood that block stripes having a lower quantity of bad blocks are assigned to the SLC memory, and block stripes having a higher quantity of bad blocks are assigned to the QLC memory. As shown in the example 410, block stripes 8, 13, 3, and 6 (having 6, 6, 5, and 5 bad blocks, respectively) may be assigned to the SLC memory, and the remainder of the block stripes may be assigned to the QLC memory. In this example, the average number of bad blocks in the SLC memory is 5.5 and the average number of bad blocks in the QLC memory is 3.0. This may reduce a likelihood of the memory device failing or needing to be discarded, for example, due to the SLC memory being able to tolerate a higher quantity of bad blocks.

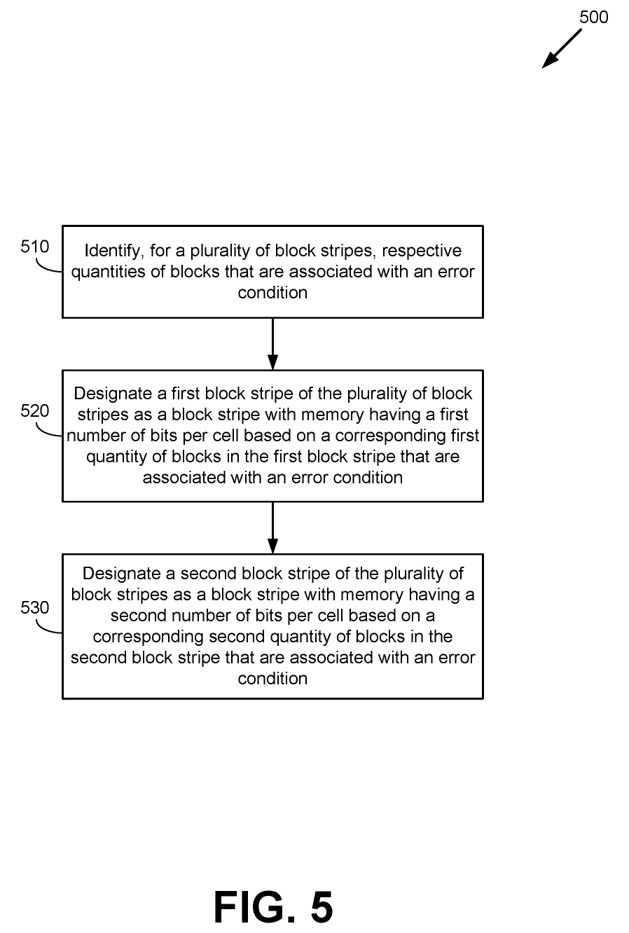

FIG. 5 is a flow diagram of an example method of managing block stripe assignment based on block error conditions, in accordance with some aspects of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, the method 500 is performed by the block stripe allocation component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

At operation 510, the processing logic identifies, for a plurality of block stripes, respective quantities of blocks that are associated with an error condition. Each block stripe of the plurality of block stripes spans the plurality of dies of a memory device. The error condition may be cause by a manufacturing defect for the memory device or by physical damage to the memory device, among other examples. The processing logic may determine a quantity of bad blocks in the block stripes using factory testing, SMART monitoring, or error checking, among other examples.

At operation 520, the processing logic designates a first block stripe of the plurality of block stripes as a block stripe with memory having a first number of bits per cell based on a corresponding first quantity of blocks in the first block stripe that are associated with the error condition. For example, block stripes having a higher quantity of bad blocks that are associated with the error condition may be designated as SLC block stripes.

At operation 530, the processing logic designates a second block stripe of the plurality of block stripes as a block stripe with memory having a second number of bits per cell based on a corresponding second quantity of blocks in the second block stripe that are associated with the error condition. For example, block stripes having a lower quantity of bad blocks that are associated with the error condition may be designated as QLC block stripes.

In some implementations, the first quantity of block stripes and the second quantity of block stripes are based on a block selection parameter. In some implementations, the block selection parameter indicates at least one of a minimum quantity of valid blocks for the block stripe with memory having the first number of bits per cell or a minimum quantity of valid blocks for the block stripe with memory having the second number of bits per cell.

In some implementations, each block stripe of the plurality of block stripes spans a plurality of logical unit numbers of the memory device. In some implementations, the processing logic may identify, for the plurality of block stripes, the respective quantities of blocks across all logical unit numbers of the memory device.

In some implementations, the processing logic may sort the plurality of block stripes into a list of block stripes ordered from the lowest quantity of blocks in the plurality of block stripes that are associated with the error condition to the highest quantity of blocks in the plurality of block stripes that are associated with the error condition.

In some implementations, designating the first block stripe as the block stripe with memory having the first number of bits per cell comprises designating the first block stripe as the block stripe with memory having the first number of bits per cell for a lifespan of the memory device, and designating the second block stripe as the block stripe with memory having the second number of bits per cell comprises designating the second block stripe as the block stripe with memory having the second number of bits per cell for the lifespan of the memory device.

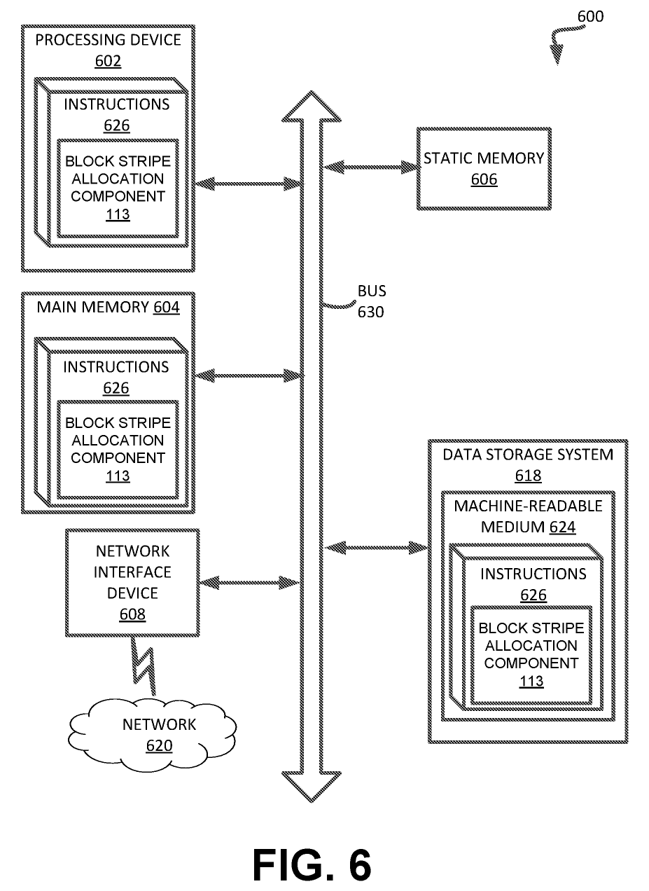

FIG. 6 illustrates an example machine of a computer system 600 within which a set of instructions, for causing the machine to perform any one or more of the methodologies discussed herein, can be executed. In some aspects, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the block stripe allocation component 113 of FIG. 1). In alternative aspects, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In some aspects, the instructions 626 include instructions to implement functionality corresponding to the sequential write component 113 of FIG. 1). While the machine-readable storage medium 624 is shown in an example aspect to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some aspects, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, aspects of the disclosure have been described with reference to specific example aspects thereof. It will be evident that various modifications can be made thereto without departing from the broader spirit and scope of aspects of the disclosure as set forth in the following claims. The specification and drawings are, accordingly, to be regarded in an illustrative sense rather than a restrictive sense.

What is claimed is:

1. A system comprising:
a memory device comprising a plurality of dies; and
a processing device, coupled with the memory device, configured to perform operations comprising:
identifying, for a plurality of block stripes, respective quantities of blocks that are associated with an error condition, wherein each block stripe of the plurality of block stripes spans the plurality of dies of the memory device;
designating a first block stripe of the plurality of block stripes as a single-level cell (SLC) block stripe based on a corresponding first quantity of blocks in the first block stripe that are associated with the error condition; and
designating a second block stripe of the plurality of block stripes as a quad-level cell (QLC) block stripe based on a corresponding second quantity of blocks in the second block stripe that are associated with the error condition, wherein the corresponding first quantity is greater than the corresponding second quantity.

2. The system of claim 1, wherein designating the first block stripe as the SLC block stripe comprises designating a first quantity of block stripes of the plurality of block stripes as SLC block stripes, and wherein designating the second block stripe as the QLC block stripe comprises designating a second quantity of block stripes of the plurality of block stripes as QLC block stripes, wherein the first quantity of block stripes and the second quantity of block stripes are based on a block selection parameter.

3. The system of claim 2, wherein the block selection parameter indicates at least one of a minimum quantity of valid blocks for the SLC block stripe or a minimum quantity of valid blocks for the QLC block stripe.

4. The system of claim 1, wherein each block stripe of the plurality of block stripes spans a plurality of logical unit numbers of the memory device, and wherein identifying, for the plurality of block stripes, the respective quantities of blocks that are associated with the error condition
comprises identifying, for the plurality of block stripes, the respective quantities of blocks across all logical unit numbers of the memory device.

5. The system of claim 4, wherein the memory device includes at least a first logical unit number stripe comprising a first subset of the plurality of logical unit numbers and a second logical unit number stripe comprising a second subset of the plurality of logical unit numbers, and wherein a plurality of SLC block stripes are divided equally between the first logical unit number stripe and the second logical unit number stripe.

6. The system of claim 1, wherein the processing device is further configured to perform operations comprising sorting the plurality of block stripes into a list of block stripes ordered from a lowest quantity of blocks in the plurality of block stripes that are associated with the error condition to a highest quantity of blocks in the plurality of block stripes that are associated with the error condition.

7. The system of claim 1, wherein designating the first block stripe as the SLC block stripe comprises designating the first block stripe as the SLC block stripe for a lifespan of the memory device, and wherein designating the second block stripe as the QLC block stripe comprises designating the second block stripe as the QLC block stripe for the lifespan of the memory device.

8. A method comprising:
identifying, for a plurality of block stripes, respective quantities of blocks that are associated with an error condition, wherein each block stripe of the plurality of block stripes spans the plurality of dies of a memory device;
designating a first block stripe of the plurality of block stripes as a block stripe with memory having a first number of bits per cell based on a corresponding first quantity of blocks in the first block stripe that are associated with the error condition; and
designating a second block stripe of the plurality of block stripes as a block stripe with memory having a second number of bits per cell based on a corresponding second quantity of blocks in the second block stripe that are associated with the error condition, wherein the corresponding first quantity is greater than the corresponding second quantity.

9. The method of claim 8, wherein the block stripe with memory having the first number of bits per cell is a single-level cell (SLC) block stripe and the block stripe with memory having the second number of bits per cell is a quad-level cell (QLC) block stripe.

10. The method of claim 8, wherein designating the first block stripe as the block stripe with memory having the first number of bits per cell comprises designating a first quantity of block stripes of the plurality of block stripes as block stripes with memory having the first number of bits per cell, and wherein designating the second block stripe as the block stripe with memory having the second number of bits per cell comprises designating a second quantity of block stripes of the plurality of block stripes as block stripes with memory having the second number of bits per cell, wherein the first quantity of block stripes and the second quantity of block stripes are based on a block selection parameter.

11. The method of claim 10, wherein the block selection parameter indicates at least one of a minimum quantity of valid blocks for the block stripe with memory having the first number of bits per cell or a minimum quantity of valid blocks for the block stripe with memory having the second number of bits per cell.

12. The method of claim 8, wherein each block stripe of the plurality of block stripes spans a plurality of logical unit numbers of the memory device, and wherein identifying, for the plurality of block stripes, the respective quantities of blocks that are associated with the error condition comprises identifying, for the plurality of block stripes, the respective quantities of blocks across all logical unit numbers of the memory device.

13. The method of claim 8, further comprising sorting the plurality of block stripes into a list of block stripes ordered from a lowest quantity of blocks in the plurality of block stripes that are associated with the error condition to a highest quantity of blocks in the plurality of block stripes that are associated with the error condition.

14. The method of claim 8, wherein designating the first block stripe as the block stripe with memory having the first number of bits per cell comprises designating the first block stripe as the block stripe with memory having the first number of bits per cell for a lifespan of the memory device, and wherein designating the second block stripe as the block stripe with memory having the second number of bits per cell comprises designating the second block stripe as the block stripe with memory having the second number of bits per cell for the lifespan of the memory device.

15. A non-transitory computer-readable storage medium comprising instructions that, when executed by a processing device, cause the processing device to perform operations comprising:
identifying, for a plurality of block stripes, respective quantities of blocks that are associated with an error condition, wherein each block stripe of the plurality of block stripes spans the plurality of dies of a memory device;
designating a first block stripe of the plurality of block stripes as a single-level cell (SLC) block stripe based on a corresponding first quantity of blocks in the first block stripe that are associated with the error condition; and
designating a second block stripe of the plurality of block stripes as a quad-level cell (QLC) block stripe based on a corresponding second quantity of blocks in the second block stripe that are associated with the error condition, wherein the corresponding first quantity is greater than the corresponding second quantity.

16. The non-transitory computer-readable storage medium of claim 15, wherein designating the first block stripe as the SLC block stripe comprises designating a first quantity of block stripes of the plurality of block stripes as SLC block stripes, and wherein designating the second block stripe as the QLC block stripe comprises designating a second quantity of block stripes of the plurality of block stripes as QLC block stripes, wherein the first quantity of block stripes and the second quantity of block stripes are based on a block selection parameter.

17. The non-transitory computer-readable storage medium of claim 16, wherein the block selection parameter indicates at least one of a minimum quantity of valid blocks for the SLC block stripe or a minimum quantity of valid blocks for the QLC block stripe.

18. The non-transitory computer-readable storage medium of claim 15, wherein each block stripe of the plurality of block stripes spans a plurality of logical unit numbers of the memory device, and wherein identifying, for the plurality of block stripes, the respective quantities of blocks that are associated with the error condition comprises identifying, for the plurality of block stripes, the respective quantities of blocks across all logical unit numbers of the memory device.

19. The non-transitory computer-readable storage medium of claim 18, wherein the memory device includes at least a first logical unit number stripe comprising a first subset of the plurality of logical unit numbers and a second logical unit number stripe comprising a second subset of the plurality of logical unit numbers, and wherein a plurality of SLC block stripes are divided equally between the first logical unit number stripe and the second logical unit number stripe.

20. The non-transitory computer-readable storage medium of claim 15, wherein the instructions, when executed by the processing device, further cause the processing device to perform operations comprising sorting the plurality of block stripes into a list of block stripes ordered from a lowest quantity of blocks in the plurality of block stripes that are associated with the error condition to a highest quantity of blocks in the plurality of block stripes that are associated with the error condition.
